(19) United States
(12) Patent Application Publication
(10) Pub. No.: US 2013/0335375 A1
(43) Pub. Date: Dec. 19, 2013

(54) CURVED TOUCH PANEL, METHOD FOR FABRICATING THE SAME, AND DISPLAY SYSTEM WITH THE SAME

(71) Applicants: Kazuhiro Nishikawa, Kyoto-shi (JP); Kazuhiko Takahata, Kyoto-shi (JP); Kazuto Nakamura, Kyoto-shi (JP); Noriaki Tsuchida, Kyoto-shi (JP); Asako Sakashita, Kyoto-shi (JP); Kenji Yotsuya, Kyoto-shi (JP); Ryohei Nagase, Kyoto-shi (JP); Akiyuki Iimuro, Kyoto-shi (JP); Jun Maruyama, Kyoto-shi (JP)

(72) Inventors: Kazuhiro Nishikawa, Kyoto-shi (JP); Kazuhiko Takahata, Kyoto-shi (JP); Kazuto Nakamura, Kyoto-shi (JP); Noriaki Tsuchida, Kyoto-shi (JP); Asako Sakashita, Kyoto-shi (JP); Kenji Yotsuya, Kyoto-shi (JP); Ryohei Nagase, Kyoto-shi (JP); Akiyuki Iimuro, Kyoto-shi (JP); Jun Maruyama, Kyoto-shi (JP)

(73) Assignee: NISSHA PRINTING CO., LTD., Kyoto-shi, Kyoto (JP)

(21) Appl. No.: 14/002,576

(22) PCT Filed: Apr. 20, 2012
(86) PCT No.: PCT/JP2012/060652

§ 371 Date: Aug. 30, 2013

(30) Foreign Application Priority Data
May 16, 2011 (JP) 2011-108964

(51) Int. Cl. G06F 3/044

(52) U.S. Cl. CPC G06F 3/044
USPC 345/174; 264/105

(57) ABSTRACT

A method for fabricating a capacitive curved touch panel is provided for solving the problems of the conventional methods, i.e., unsuitableness of the methods for mass production and fabricating large touch panels and touch panels of complicated curved surface shapes. The method includes the steps of (a) preparing a patterned plate 13 by forming an electrode layer having a plurality of electrode regions 15 on a thermoplastic resin plate 11 with an electrically-conductive ink comprised of an electrically-conductive substance and a binder, (b) preparing a soft curved product 21 by heating to soften the patterned plate 13 and shaping the softened patterned plate on a die 22, and (c) cooling or allowing to cool the soft curved product to make the touch panel.

### TECHNICAL FIELD

The present invention relates to a capacitive touch panel having a curved touch surface, more specifically, a touch panel having a unique electrode composition.

Further the present invention relates to a method for fabricating the touch panel and a display system to which the touch panel is built in.

### BACKGROUND ART

In the conventional technology, capacitive touch panels having a curved touch surface and a light scattering layer on their rear side have already been proposed (for example, those disclosed in Patent literature 1). Such conventional touch panels have electrodes for sensing a touch which consist of a transparent conductive membrane formed of specific metal oxides such as ITO (indium tin oxide), IZO (indium zinc oxide) and SnO₂ (tin oxide). The conductive membrane is formed in vacuum plating, such as sputtering.

Touch panels usually function to determine the location of a touch, and for this purpose a plurality of electrodes are required to be precisely formed on a touch surface.

Curved touch panels fabricated by forming a layer of a specific metal oxide on a curved substrate require pneumatic plating in their fabrication process, and materials employable for the curved substrate are restricted within those durable against pneumatic plating, such as soda glass, borosilicate glass and heat-resistant glasses.

The pneumatic plating included in the methods for fabricating the conventional curved touch panels makes the methods unsuitable for mass production or causes difficulty in producing large touch panels. In addition, it is difficult in the conventional fabrication methods to precisely form a plurality of electrodes on a curved touch panel of a complicated curved surface shape.

Further, a display system having a curved touch panel has limited application because of the material of the touch panel being restricted within glasses which are not resistant to an accidental shock. In addition, such system has several disadvantages including high production cost, unsuitableness for large size and impossibility for employing a display unit of a complicated curved surface shape.

### CITATION LIST

### Patent Literature

PTL 1; Japanese patent publication laid open 2007-279819

### SUMMARY OF INVENTION

### Technical Problem

The problem to be solved by the present invention relating to a curved touch panel is the narrow scope of materials selectable for fabricating a curved touch panel. Further the problems to be solved by the present invention relating to a method for fabricating a curved touch panel are the unsuitableness of the conventional methods for mass production, large touch panels and touch panels of complicated curved surface shapes. Further the problem to be solved by the present invention relating to a display system in which a touch panel is built in is the limited application of a display system with a touch panel because of the susceptibleness of a touch panel to an accidental shock.

Other problems to be solved by the present invention will become apparent from the detailed description to follow.

### Solution to Problem

The means for solving the problems are explained in the following description.

A touch panel according to one embodiment of the present invention is a capacitive touch panel having a curved touch surface that is fabricated; forming an electrode layer having a plurality of electrode regions on a thermoplastic resin plate with an electrically-conductive ink comprised of an electrically-conductive substance and a binder to prepare a patterned plate, said patterned plate is heated and softened to be shaped into a soft curved product; and said curved product is cooled or allowed to cool to be made into said touch panel.

The touch panel of the present invention can be practiced according to the following preferable embodiments.

(1) The thermoplastic resin plate is a light-scattering resin plate.

(2) Said electrically-conductive substance in said electrically-conductive ink comprised of said electrically-conductive substance and said binder, is carbon nanotube.

(3) Said electrode layer comprises a first electrode layer and a second electrode layer being superposed over said first electrode layer without direct contact, each of said first electrode layer and second electrode layer has a plurality of electrode regions, and one electrode region contained in said first electrode layer overlaps with at least two electrode regions contained in said second electrode layer.

(4) Said plurality of the electrode regions contained in the electrode layers are formed by dividing an area coated with the electrically-conductive ink, which covers the whole area of the plurality of the electrode regions, by means of photolithography.

The method for fabricating the touch panel according to another embodiment of the present invention is a method for fabricating a capacitive touch panel having a curved touch surface and includes the following steps of:
(a) preparing a patterned plate by forming an electrode layer having a plurality of electrode regions on a thermoplastic resin plate with an electrically-conductive ink comprised of an electrically-conductive substance and a binder;
(b) heating and softening said patterned plate, and shaping said patterned plate into a soft curved product; and
(c) cooling or allowing to cool said soft curved product to make said touch panel.

The display system having a touch panel according to yet another embodiment of the present invention comprises an image projection unit, a light-path-reflecting mirror, a touch panel of the present invention, a touch panel controller, a computer and an image memory unit. Said computer transmits an image data stored in said image memory unit to said image projection unit, said image projection unit produces and projects the image onto the light-path-reflecting mirror, said light-path-reflecting mirror reflects the incoming image and projects it onto said touch panel, and said touch panel displays the projected image. The electrode regions of said touch panel are electrically connected to said touch panel controller, said touch panel controller monitors the capacitance in the electrode regions to detect a change in the capacitance and upon the detection transmits a touch signal to said computer, and said computer receives the signal and executes a processing as previously programmed.

The display system having a touch panel of the present invention can be practiced according to the preferable embodiment described below.

(1) The system may further comprise a LAN (local area network) unit connected to a network, which receives a signal from said network and transmit the signal to said computer to make said computer execute a processing according to the signal.

(2) The system may further comprise a load sensor mounted at the position where the touch panel is attached to the system, and also a load sensor controller. Said load sensor is electrically connected to said load sensor controller, said load sensor controller monitors the load received by said load sensor to detect a change in the load and upon the detection transmits a signal of the change in load to said computer, and said computer receives the signal and executes a processing as previously programmed.

(3) The system may further comprise an audio amplifier and a speaker utilizing said touch panel as a diaphragm. The source of vibration for said speaker is mechanically connected to said touch panel and the output from said audio amplifier is input to the source of vibration to be produced into sound.

The present invention, the preferred embodiments of the present invention, and the constituent elements include in them as described above may be embodied in other forms when they are combined to as much extent as possible.

### ADVANTAGEOUS EFFECTS OF INVENTION

The advantages of the curved touch panel of the present invention include the wide array of materials employable for the touch panel, because the touch panel is fabricated, among others, through the steps of forming a plurality of electrode regions with an electrically-conductive ink on a thermoplastic resin plate, heating to soften the plate and shaping the plate into the curved touch panel.

The advantages of the method for fabricating the curved touch panel of the present invention include the applicability of the method to mass production and fabricating large touch panels and the facility of the method for fabricating curved touch panels of complicated curved surface shapes, because the method comprises, among others, the steps of forming an electrode layer on a thermoplastic resin plate to process it into a patterned plate, heating to soften the patterned plate, and shaping the softened patterned plate.

The advantage of the display system having a touch panel of the present invention includes the wide application range of the system, because the touch panel comprises, among others, a thermoplastic resin which is resistant to an accidental shock.

### BRIEF DESCRIPTION OF DRAWINGS

FIG. 1 is the illustrative diagram of a display system having a touch panel.

FIG. 2 is the illustrative diagram of a method for fabricating a touch panel, wherein FIG. 2(a) is a plan view of a plate, FIG. 2(b) is a plan view of a patterned plate, FIG. 2(c) is an illustrative diagram of processing a soft curved product, and FIG. 2(d) is a perspective view of a touch panel.

FIG. 3 is the illustration of the electrode patterns of the touch panel having grid-partitioned detection parts (the second touch panel), and shows the overhead view of the second touch panel.

FIG. 4 is the sectional view of the second touch panel.

FIG. 5 is the process diagram illustrating the fabrication of the second touch panel.

### DESCRIPTION OF EMBODIMENTS

Referring to the drawings, the touch panel, method for fabricating the touch panel and display system having the touch panel according to the embodiments of the present invention are further described. Some of the elements in the figures are magnified for easy understanding of the present invention. Thus some of the dimensions or dimensional ratio between the elements may be different from actual touch panels and display systems. The dimensions, materials, forms and relative positions of the members and parts described in the working examples of the present invention merely explain the present invention and do not intend to restrict the scope of the present invention unless otherwise specified. The numbers used as the signs may collectively represent parts, and an alphabetical letters is sometimes added to such numbers for representing each of such parts.

The display system 1 having the touch panel includes an image projection unit 51, a light-path-reflecting mirror 52, and the touch panel 10. The audiovisual memory unit 56 also functions as image memory unit and stores image data and audio data. The audiovisual controller 57 selectively pulls up image data from the audiovisual memory unit 56 and transmits the data to the image projection unit 51. The image data can either be still-image data, moving image data or a mixture thereof.

The image projection unit 51 converts the image data into an image and projects it. The image projection unit can be, for example, a unit with a transmissive liquid crystal panel, reflective liquid crystal panel or a DMD (digital micromirror device).

The audiovisual controller 57 also functions as an audio amplifier. The audiovisual controller 57 converts audio data into sounds and voices and amplifies audio signals. The amplified audio signals are input to the speakers 58a and 58b and reproduced into sounds and voices with the speakers 58a and 58b.

The light-path-reflecting mirror 52 reflects an image projected from the image projection unit 51 and output the image to the touch panel 10. The light-path-reflecting mirror 52 enables to avoid excessively long straight light path, which would be required in the display system 1 having the touch panel if the light path was not reflected with the light-path-reflecting mirror. The light-path-reflecting mirror is especially required for a display system with a large touch panel 10, in which the distance between the rear side of the touch panel and the end of the display system becomes excessively large without the reflecting mirror.

A convex mirror employed as the light-path-reflecting mirror 52 decreases the deformation in an image displayed on the touch panel 10. The effect of decreasing the deformation is greater for a larger touch panel 10.

The touch panel 10 is a curve-surfaced product fabricated by forming a plurality of electrode regions of an electrically-conductive ink layer on a thermoplastic resin plate, heating and softening the plate to shape it into curved plate, and cooling or allowing to cool the shaped product.

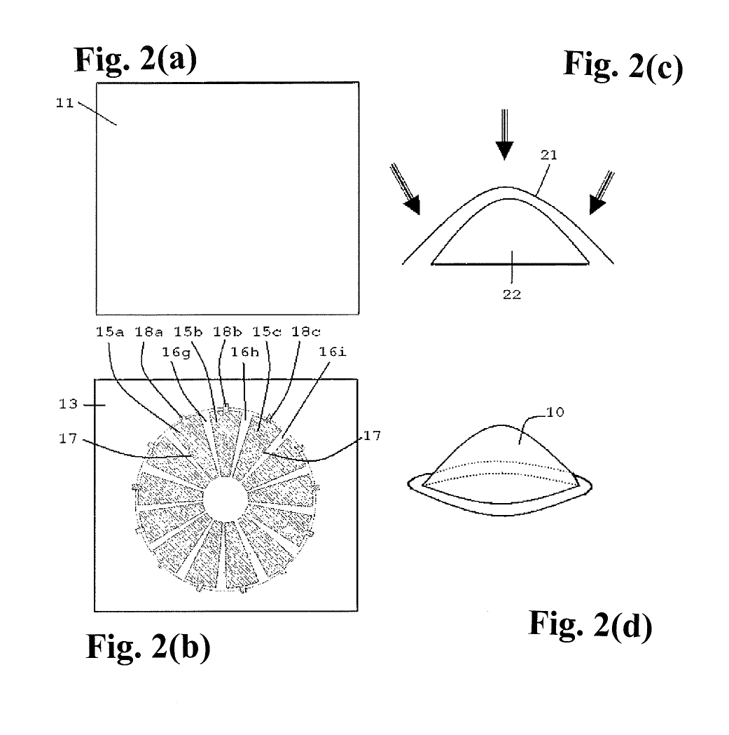

FIG. 2 is the illustrative diagram of a method for fabricating a touch panel.

At first, a plate 11 was prepared referring to FIG. 2(a). The plate 11 is made of a thermoplastic resin which softens with heat and hardens with cooling. The resin is solid at room temperature. The examples of the thermoplastic resins include acrylic resins, fluorine resins, polycarbonate resins, polyester resins, polystyrene resins, acrylonitrile-butadiene-styrene resins, polypropylene resins, polyacrylonitrile resins, polyamide resins, polyurethane resins and vinyl ester resins.

The thickness of the plate 11 is not specifically restricted, and can be determined according to the dimension of the final product, a touch panel, and the properties of a resin to be employed.

Electrode regions are formed on the plate 11 with an electrically-conductive ink. The electrically-conductive ink is made by mixing electrically-conductive particles in a binder. The examples of the electrically-conductive particles include carbon nanotube, silver nanofiber, copper nanofiber, and PEDOT (polyethylenedioxythiophene) which is an electrically-conductive, resin polymer particle. Of those nanoparticles, carbon nanotube makes an electrically-conductive ink of the lowest price, and contributes to lower price of the touch panel

The shape of the electrically-conductive particles is granular or fiber-like. The dimensions of the fiber-like particles range usually from 1 nm (nanometer) to 100 nm and preferably from 5 nm to 50 nm in diameter, and usually from 10 nm to 1 mm (millimeter) and preferably from 50 nm to 500 pm (micrometer) in length. The dimension of the granular particles ranges usually from 1 nm to 100 nm and preferably from 5 nm to 50 nm in average diameter.

The examples of the binder include acrylic resins, vinyl chloride resins, vinyl chloride-vinyl ester copolymer resins, EVA resins, polyurethane resins, polyacetate resins, chlorinated polypropylene resins and polyester resins.

The ratio of electrically-conductive particles to a binder in an electrically-conductive ink ranges usually from 1 to 100 parts by weight and preferably from 2 to 95 parts by weight, to 100 parts by weight of the binder. The thickness of the resultant electrically-conductive ink layer ranges usually from 1 nm to 100 μm (micrometer), and preferably from 2 nm to 50 μm (micrometer). The sheet resistivity of the electrically-conductive ink layer ranges usually from 1 to 2000 ohm/sq. and preferably from 5 to 1000 ohm/sq. The transmittance of visible light through the electrically-conductive ink layer ranges usually from 1 to 100%, and preferably from 10 to 100%.

On the plate 11, a plurality of electrode regions are formed with an electrically-conductive ink. The electrode regions can be printed with gravure printing or screen printing.

The electrode regions can also be formed with photolithography with either positive or negative type photoresist. An example of the procedure of the photolithography is as follows.

(1) A photoresist covering the whole area of a plurality of electrode regions is applied onto the electrode regions with a coater or sprayer.

(2) A continuous electrically-conductive ink layer is formed on the photoresist. The electrically-conductive ink layer can be applied onto the photoresist either continuously or discontinuously, for example, in a fine lattice pattern. Continuous coating can be implemented with a coater or sprayer, and coating in a fine lattice pattern can be implemented with a printing method such as gravure printing or screen printing.

(3) The photoresist is exposed to ultraviolet lay, laser light or the like to form the electrode regions of an intended pattern.

(4) The photoresist exposed to light is washed away in a solvent or the like and the electrically-conductive ink layer on the photoresist being washed away is lifted off.

The electrode regions can be more precisely patterned with photolithography.

FIG. 2(b) is a plan view of a patterned plate 13. The electrode regions 15a, 15b And 15c are patterned on one side of the patterned plate 13. The lead wires 18a, 18b and 18c are respectively extended from each of the electrode regions. This embodiment is an example of electrode regions patterned with photolithography. The profile lines of the electrode regions 15a, 15b and 15c represent the cut lines 17 resulting from the lifting off. The cut lines 17 are noncurrent carrying parts.

The regions of electrically-conductive ink layer are placed between electrode regions 15. The regions of electrically-conductive ink layer are the reference electrode regions 16. For example, the electrode region 16g exists between the electrode regions 15a and 15b, and the electrode region 16h exists between the electrode regions 15b and 15c.

The electrode regions 15, reference electrode regions 16 and lead wires 18 on the patterned plate 13 are designed to make allowance for deformation and strain caused by mechanical stress in subsequent processes to shape curved surface shape.

Then the patterned plate 13 is heated and softened. The plate is kept soft and shaped into curved surface shape on a die. The shaping can be carried out with pressure forming, vacuum forming or hot pressing, preferably with pressure forming or vacuum forming.

FIG. 2(c) shows an example of pressure forming. Pressure is applied to the patterned plate on the die 22 in the direction indicated by the arrows in the figure and the patterned plate is shaped into a soft curved product 21.

When the patterned plate is shaped into the curved product, the electrode layers are deformed or strained due to tensile stress or compression stress. The electrically-conductive ink layer transforms along with such strain and the like, and keeps the electrical conductivity in the electrode regions unlike layers of specific metal oxides, such as ITO.

The soft curved product 21 is allowed to cool. Then the unnecessary peripheral margin of the product is trimmed to make a curve-surfaced product, i.e., the touch panel 10. In this embodiment, the touch panel 10 is shaped into hemispherical shape having a circular base of 150 mm (millimeter) in radius and a height of 200 mm from the base to the top. The plate is a 1.0 mm (one millimeter) thick acrylic resin plate.

The touch panel 10 can be light-scattering or not. A light-scattering material is preferable for the touch panel 10 used as a screen for displaying projected image. An example of a light-scattering touch panel is a touch panel of the milky white acrylic resin plate 11.

A light-scattering material is not necessary for a touch panel to be incorporated in a touch-panel system which contains a screen solely used for displaying projected image, or for a touch panel to be incorporated in a touch-panel system which contains a liquid crystal display attached at the rear side of the touch panel.

The touch panel 10 may either be colorless or colored.

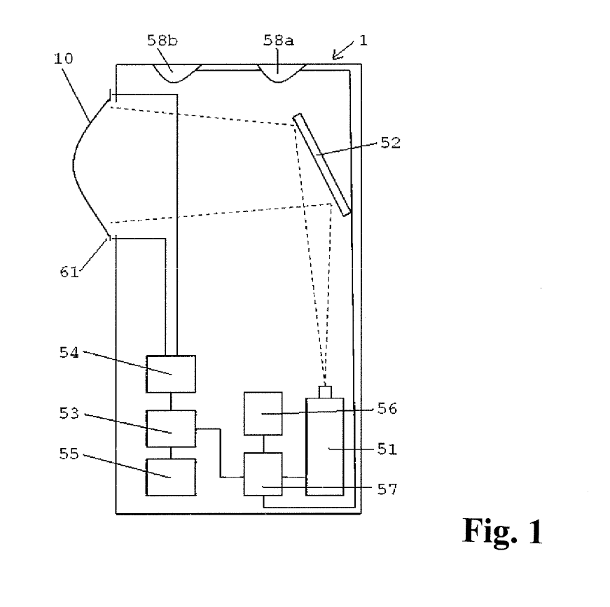

The display system 1 having a touch panel is explained again referring to FIG. 1.

The touch panel 10 is a curve-surfaced product of a milky white thermoplastic resin plate. In other words, the touch panel 10 is made of a light-scattering resin. Image light projected from the image projection unit 51 is scattered by the touch panel 10 and an observer sees image on the touch panel.

The lead wires 18 equipped with the touch panel are connected to the touch panel controller 54. The touch panel controller 54 is a device to detect a touch by measuring variation of capacitance. The touch panel controller 54 has an oscillating circuit, decision circuit and signal generation circuit. The oscillating circuit generates variable oscillation frequency according to the capacitance values of the electrode regions. The decision circuit detects a change in the oscillation frequency. The signal generation circuit transmits a touch signal to the computer 53 when the decision circuit detects a change in the oscillation frequency. The capacitance values of the electrode regions are derived from a comparative calculation with the capacitance values of the reference electrode regions.

When the touch panel 10 is separate from a human finger, the capacitance values of the electrode regions are kept at a constant value, and the oscillating circuit generates a constant oscillation frequency. When a human finger comes close to or contacts electrode regions of the touch panel 10, the capacitance of the electrode regions changes to change the oscillation frequency, and the decision circuit detects the change in the oscillation frequency. Then the signal generation circuit transmits the touch signal to the computer 53 and the computed 53 receives the touch signal to execute a task previously programmed. Examples of the previously programmed tasks include selecting projected images, scaling the images, selecting sounds, controlling volume, and turning on or off the display system 1 having a touch panel.

The computer 53 controls the units and parts mentioned above and also controls the whole system of the display system 1 having a touch panel.

The display system 1 having a touch panel can include a LAN controller 55. The LAN controller 55 is connected to a LAN. The LAN controller 55 functions to take in image data and audio data stored in the audiovisual memory unit 56, replace the data, change the program in the computer 53, perform remote maintenance, and play back contents from internet broadcasting.

The display system 1 having a touch panel can have a load sensor at the attaching position 61 of the touch panel 10 and have a load sensor controller connected to the computer 53. The load sensor is electrically connected to the load sensor controller. The display system preferably has a plurality of load sensors, because a single load sensor senses a change in load caused by a touch with a finger on the touch panel 10 and determines the change in load simultaneously as a touch and a push.

The load sensor detects a change in load caused by pushing the touch panel 10 and changes the quantity of the load signal transmitted to the load sensor controller which determines the change in the quantity of the load signal and transmits a changed-load sensing signal to the computer 53. The changed-load sensing signal should preferably be transmitted after calculating the change in the quantity of load signals from a plurality of load sensors, for the purpose of determining, for example, the direction of a push on the touch panel 10. The function enables the touch panel 10 to be used as an input device like a joystick.

The computer 53 receives the changed-load sensing signal and executes a task previously programmed.

The touch panel 10 can also function as a diaphragm of a speaker. A large curved touch panel fabricated according to the present invention can be a large diaphragm which implements megavolume and high-quality sound. Thus a diaphragm of a speaker is a preferable application of the touch panel of the present invention.

The examples of the source of vibration for the speaker include:
(1) permanent magnet and voice coil, and
(2) piezoelectric element

In other words, the display system 1 having a touch panel can include permanent magnet and voice coil. The voice coil is arranged close to the permanent magnet, preferably in a cylinder of permanent magnet. The output from the audio amplifier in the audiovisual controller 57 is input to the voice coil. The voice coil is mechanically connected to the touch panel 10. Thus the touch panel 10 functions as a diaphragm of a speaker.

A piezoelectric element used as the source of vibration for a speaker is mechanically connected to the touch panel 10. The output from the audio amplifier in the audiovisual controller 57 is input to the piezoelectric element, and the touch panel 10 functions as a diaphragm as mentioned above.

The touch panel 10 described above has a single electrode layer which is divided into sector-shaped electrode regions arranged along the longitude lines of the hemisphere-shaped touch panel. The terms, longitude lines and latitude lines, in the present invention mean the longitude lines and latitude lines defined with the pole positioned at the top of the hemispherical touch panel 10 and the equator positioned at the attaching position 61 of the touch panel to the display system 1 having a touch panel. When the touch panel 10 is incorporated into an input unit for the touch panel, touching to the touch panel is detected by each of the electrode regions mentioned above.

The touch panel of the present invention can have a plurality of electrode layers which are formed into grid-partitioned detection parts. An example of the grid partitioning is the grids sectioned along the longitude lines and latitude lines of the hemispherical touch panel.

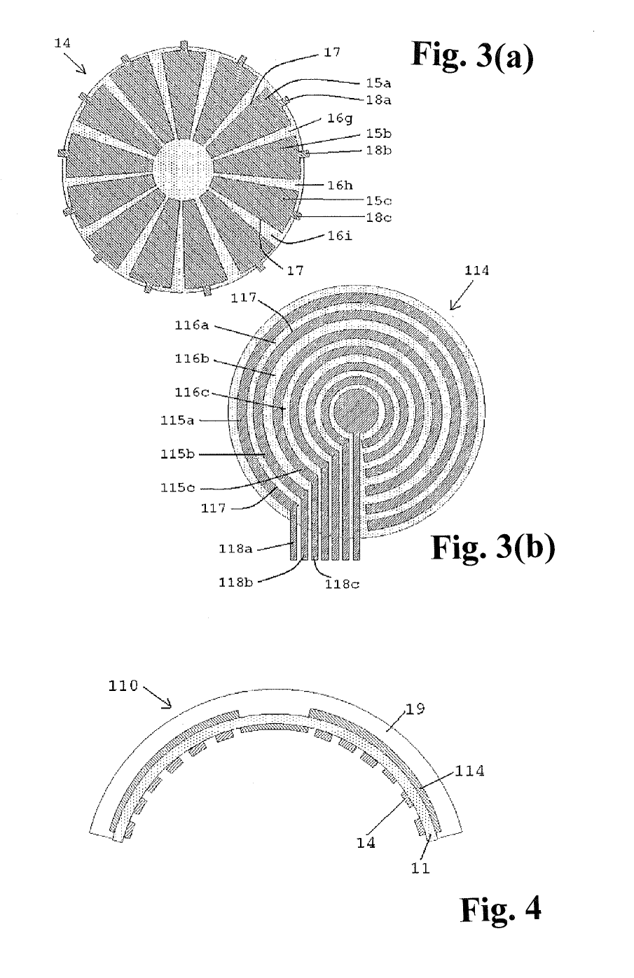

FIG. 3 is the illustration of the electrode patterns of the touch panel having grid-partitioned detection parts (the second touch panel), and shows the overhead view of the second touch panel 110.

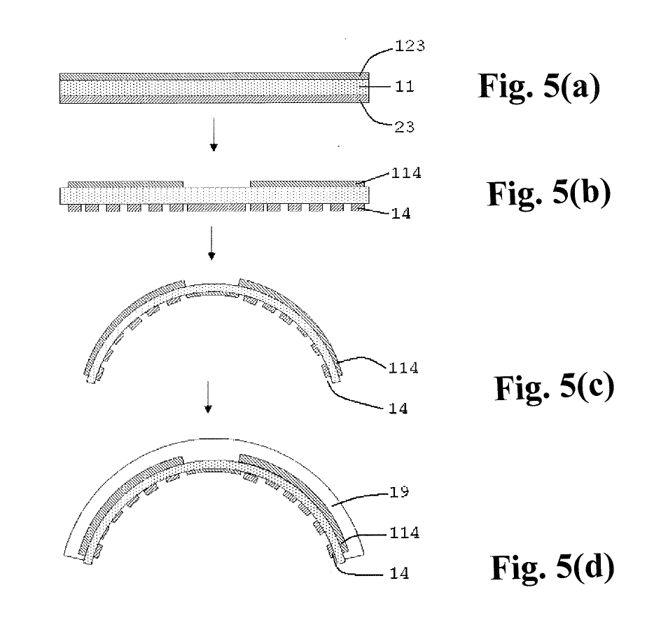

FIG. 4 is the sectional view of the touch panel having grid-partitioned detection parts formed with the electrode layers disposed on both sides of the panel (the second touch panel). FIG. 5 is the process diagram illustrating the fabrication of the second touch panel.

FIG. 3(a) shows the pattern of the electrode regions 15 at the first electrode layer 14 and FIG. 3(b) shows the pattern of the electrode regions 115 at the second electrode layer 114. The pattern of the electrode regions at the first electrode layer 14 is the same as the pattern of the electrode layer of the touch panel 10. Each of the electrode regions 15 extends along the latitude lines. The electrode regions 15a, 15b and 15c, the lead wires 18a, 18b and 18c, and the reference electrode regions 16a, 16b and 16c are marked with the same signs as those for the figure illustrating the touch panel 10.

The electrode regions patterned in the second electrode layer 114 are designed into concentric circles of 115a, 115b and 115c, and the lead wires 118a, 118b and 118c are extended from each of the electrode regions 115a, 115b and 115c to the base of the hemispherical touch panel. The electrically-conductive ink layer is cut at the cut lines 117. The reference electrode regions 116a, 116b and 116c exist between the electrode regions 115a, 115b and 115c. The electrode regions patterned in the second electrode layer extend along the latitude lines of the hemispherical touch panel.

Referring to FIG. 4, the second electrode layer 114 is superposed over the first electrode layer 14 without direct contact by forming the first electrode layer 14 on the rear side of the plate 11 and forming the second electrode layer 114 on the front side of the plate 11, and thus the second touch panel 110 is produced.

The method for fabricating the second touch panel 110 is briefly explained referring to FIG. 5. The method for fabricating the second touch panel 110 is almost the same as the method for fabricating the touch panel 10. Thus only the difference in the methods is mentioned here.

At first, electrically-conductive ink layers 23 and 123 are formed on the rear and front sides of the plate 11 with coating or other means (FIG. 5(a)).

Then the electrically-conductive ink layer 23 on the rear side is formed into the pattern of the first electrode layer 14, and the electrically-conductive ink layer 123 on the front side is formed into the pattern of the second electrode layer 114 to prepare the patterned plate (FIG. 5(b)).

The patterned plate is heated, shaped and cooled or allowed to cool (FIG. 5(c)).

Finally, a protective layer is formed onto the second electrode layer 114 to be processed into the touch surface. The examples of the materials for the protective layer include activation-energy-curable resins which are curable with ultraviolet ray or electron beam and represented by light-curable resins such as UV-curable resins and radiation-curable resins such as electron-beam-curable resins; and thermosetting and activation-energy-curable resins.

The second touch panel having the first electrode layer and the second electrode layer respectively formed on each side of the base material has been described above as an example of a touch panel having grid-partitioned detection parts. Similar touch panels can be fabricated by laminating two plates prepared by forming the first electrode layer on one side of a substrate and forming the second electrode layer on one side of another substrate.

### REFERENCE SIGNS LIST

1 Display system having a touch panel
10 Touch panel
11 Plate
13 Patterned plate
14 First electrode layer
15 Electrode region (along longitude lines)
16 Reference electrode region (along longitude lines)
17 Cut line (noncurrent carrying part)
18 Lead wire
19 Protective layer
21 Soft curved product
22 Die
51 Image projection unit
52 Light-path reflecting mirror
53 Computer
54 Touch panel controller
55 LAN unit
56 Audiovisual memory unit also functioning as an image memory unit
57 Audiovisual controller also functioning as an audio amplifier
58 Speaker
61 Attaching position
110 Second touch panel (touch panel having grid-patterned detection parts)
114 Second electrode layer
115 Electrode region (along longitude lines)
116 Reference electrode region (along latitude lines)
117 Cut line (noncurrent carrying part)
118 Lead wire

1-10. (canceled)

11. A method for fabricating a capacitive touch panel having a curved touch surface, comprising the steps of:
(a) preparing a patterned plate by forming an electrode layer having a plurality of electrode regions on a thermoplastic resin plate with an electrically-conductive ink comprised of an electrically-conductive substance and a binder;
(b) heating and softening said patterned plate, and shaping said patterned plate into a soft curved product; and
(c) cooling or allowing to cool said soft curved product to make said touch panel.

12. A method for fabricating a capacitive touch panel according to claim 11, wherein said thermoplastic resin plate is a light-scattering resin plate.

13. A method for fabricating a capacitive touch panel according to claim 11, wherein said electrically-conductive substance in said electrically-conductive ink comprised of said electrically-conductive substance and said binder, is carbon nanotube.

14. A method for fabricating a capacitive touch panel according to claim 11, wherein said electrode layer comprises a first electrode layer and a second electrode layer superposed over said first electrode layer, each of said first electrode layer and second electrode layer has a plurality of electrode regions, and one electrode region contained in said first electrode layer overlaps with at least two electrode regions contained in said second electrode layer.

15. A method for fabricating a capacitive touch panel according to claim 11, wherein said plurality of the electrode regions contained in said electrode layers are formed by dividing an area coated with the electrically-conductive ink, which covers a whole area of the plurality of the electrode regions, by means of photolithography.

16. A display system comprising:
a curved capacitive touch panel having a curved touch surface, said touch panel including a patterned plate formed of a light-scattering thermoplastic resin plate; and an electrode layer having a plurality of electrode regions on the thermoplastic resin plate electrically separated from each other, said electrode regions being formed of an electrically-conductive ink comprised of an electrically-conductive substance and a binder;
an image memory unit for storing an image data therein;
a computer for transmitting the image data;
an image projection unit for producing a projected image from the image data transmitted by the computer;
a light-path-reflecting mirror for reflecting the projected image projected from the image projection unit; and
a touch panel controller for monitoring a change of a capacitance in the electrode regions, the touch panel controller connecting electrically to the electrode regions of the tough panel,
wherein the touch panel displays the projected image reflected by the light-path-reflecting mirror, and
the touch panel controller transmits a touch signal to the computer when the change of the capacitance is detected, and the computer executes a predetermined processing when the touch signal is received.

17. A display system according to claim 16, further comprising a LAN (local area network) unit connected to a network,
wherein the LAN receives a signal from said network and transmits the signal to said computer such that said computer executes a processing according to the signal.

18. A display system according to claim 16, further comprising a load sensor mounted at a position where the touch panel is attached to said system, and a load sensor controller;
wherein said load sensor is electrically connected to said load sensor controller, said load sensor controller monitors a change in a load sensed by said load sensor, detects the change in the load, and upon detection of the change, transmits a signal of the change in the load to said computer, and said computer receives the signal and executes a predetermined processing.

19. A display system according to claim 16, further comprising an audio amplifier and a speaker utilizing said touch panel as a diaphragm;
wherein a source of vibration for said speaker is mechanically connected to said touch panel and an output from said audio amplifier is input to the source of vibration to produce sound.
